(19) United States
(12) Patent Application Publication
(10) Pub. No.: US 2008/0107198 A1
(43) Pub. Date: May 8, 2008

(54) Method and apparatus for performing multi-input multi-output transmission in a wireless communications system

(75) Inventor: Yu-Chih Jen, Taipei City (TW)

Correspondence Address: BIRCH, STEWART, KOLASCH & BIRCH, LLP, 8110 GATEHOUSE ROAD, SUITE 100 EAST, FALLS CHURCH, VA, 22315, US

(73) Assignee: Innovative Sonic Limited, Tortola (VG)

(21) Appl. No.: 11/979,694

(22) Filed: Nov. 7, 2007

Related U.S. Application Data
(60) Provisional application No. 60/857,187, filed on Nov. 7, 2006.
(60) Provisional application No. 60/864,962, filed on Nov. 8, 2006.
(60) Provisional application No. 60/857,803, filed on Nov. 9, 2006.

(51) Int. Cl. H04L 27/28

(52) U.S. Cl. 375/260

(57) ABSTRACT

A method for performing MIMO transmission in a network of a wireless communications system is disclosed. The method includes transmitting at least one traffic attribute corresponding to at least one HARQ entity or at least one HARQ process to a user equipment, called UE hereinafter, when the network performs downlink MIMO transmission through the at least one HARQ entity or the at least one HARQ process.

### CROSS REFERENCE TO RELATED APPLICATIONS

This application claims the benefit of U.S. Provisional Application No. 60/857,187, filed on Nov. 7, 2006 and entitled “Method and Apparatus for Realizing Uplink HARQ Operation with MIMO Technology”, the benefit of U.S. Provisional Application No. 60/864,962, filed on Nov. 8, 2006 and entitled “Method and Apparatus for realizing Uplink HARQ operation with MIMO technology”, and the benefit of U.S. Provisional Application No. 60/857,803, filed on Nov. 9, 2006 and entitled “Method and Apparatus for realizing Uplink HARQ operation with MIMO technology”, the contents of which are incorporated herein by reference.

### BACKGROUND OF THE INVENTION

1. Field of the Invention

The present invention relates to a method and apparatus for performing multi-input multi-output transmission in a wireless communications system, and more particularly, to a method and apparatus for accurately performing multi-input multi-output transmission.

2. Description of the Prior Art

Multi-input and multi-output, or MIMO, refers to the use of multiple antennas both at the transmitter and receiver to improve the performance of a radio communications systems. MIMO technology has attracted attention in wireless communications, since it offers significant increases in data throughput and link range without additional bandwidth or transmit power.

Generally, MIMO technology can be classified into the following operating modes, including:

1. Spatial Multiplexing (SM): In the transmitter, a high rate signal is split into multiple lower rate streams and each stream is transmitted from a different antenna in the same frequency channel. SM is very powerful technique for increasing channel capacity at higher Signal to Noise Ratio (SNR).

2. Transmit Diversity (TD, or named spatial diversity): A single stream is received or transmitted though multiple paths established by multiple antennas, so that transmission quality can be enhanced.

3. Beamforming: When receiving a signal, beamforming can increase the receiver sensitivity in the direction of wanted signals and decrease the sensitivity in the direction of interference and noise. When transmitting a signal, beamforming can increase the power in the direction the signal is to be sent.

The above-mentioned operating modes can be used in coordination.

A new mobile communications system, such as Long Term Evolution (LTE) wireless communications system, is an advanced high-speed wireless communications system established upon the 3G mobile telecommunications system, and uses technologies of High Speed Downlink Package Access (HSDPA) and High Speed Uplink Package Access (HSUPA), to increase bandwidth utility rate and package data processing efficiency to improve uplink/downlink (UL/DL) transmission rate. HSDPA and HSUPA adopt Hybrid Automatic Repeat Request (HARQ) technology to enhance retransmission rate and reduce transmission delay. HARQ is a technology combining Feed-forward Error Correction (FEC) and ARQ methods, and uses a “Multi-channel Stop and Wait” algorithm, meaning that each channel decides to retransmit a packet or transmit the next packet according to positive/negative acknowledgement signals (ACK/NACK) reported by the receiver.

The LTE system can reach high transmission speed and large channel capacity under a limited frequency spectrum. Such operation requires high bandwidth utility rate. Therefore, the prior art has introduced MIMO into LTE, so as to multiply channel capacity without additional bandwidth or transmit power.

Due to MIMO, since transport blocks (data or control message) will be processed by different HARQ entities, the number of HARQ entities can be multiplied (depending on how many antennas). It means that each HARQ entity shall maintain its own transmission attributes (i.e. the Resource unit (RU) allocation, Modulation, coding and transport block size, and duration of the retransmission) being coincide or different, and HARQ operation may be affected based on what kind of MIMO mode it applies. In addition, the synchronous HARQ operation at Uplink is temporarily assumed while adaptive and asynchronous features are For Further Study (FFS).

On the other hand, in UL, due to the transport block characteristic, transmission resource and system load, transmission frequency, and importance and so on, it's expected that different MIMO mode would be utilized. This would determine different behavior at resource (grant) allocation by Scheduling Information (SI) messages, which are transmitted from the network, and utilized for indicating the granted transmission resources for UL transmission of user equipments (UEs). Moreover, in response to data transmission, transmission of control signaling may require different MIMO mode and resources as well as thus handling in various ways to provide necessary information. However, different MIMO modes are not permissibly used for different UEs simultaneously in UL multi-user MIMO (MU-MIMO).

### SUMMARY OF THE INVENTION

According to the present invention, a method for performing MIMO transmission in a network of a wireless communications system is disclosed. The method comprises transmitting at least one traffic attribute corresponding to at least one HARQ entity or at least one HARQ process to a user equipment, called UE hereinafter, when the network performs downlink MIMO transmission through the at least one HARQ entity or the at least one HARQ process.

According to the present invention, a communications device for accurately performing MIMO comprises a control circuit for realizing functions of the communications device, a processor installed in the control circuit, for executing a program code to command the control circuit, and a memory installed in the control circuit and coupled to the processor for storing the program code. The program code comprises transmitting at least one traffic attribute corresponding to at least one HARQ entity or at least one HARQ process to a user equipment, called UE hereinafter, when the network performs downlink MIMO transmission through the at least one HARQ entity or the at least one HARQ process.

According to the present invention, a method for performing MIMO transmission in a network of a wireless communications system is disclosed. The method comprises performing a power control procedure for uplink transmission of a MIMO user equipment, called UE hereinafter, when the MIMO UE performs uplink transmission.

According to the present invention, a communications device for accurately performing MIMO comprises a control circuit for realizing functions of the communications device, a processor installed in the control circuit, for executing a program code to command the control circuit, and a memory installed in the control circuit and coupled to the processor for storing the program code. The program code comprises performing a power control procedure for uplink transmission of a MIMO user equipment, called UE hereinafter, when the MIMO UE performs uplink transmission.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a function block diagram of a wireless communications device.

FIG. 2 is a diagram of program code of FIG. 1.

FIG. 3 is a flowchart of a process according to an embodiment of the present invention.

FIG. 4 is a flowchart of a process according to another embodiment of the present invention.

### DETAILED DESCRIPTION

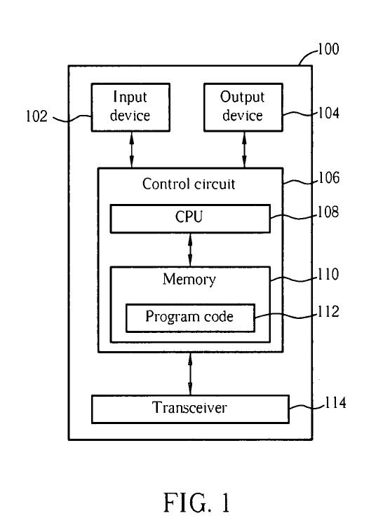

Please refer to FIG. 1, which is a functional block diagram of a communications device 100. For the sake of brevity, FIG. 1 only shows an input device 102, an output device 104, a control circuit 106, a central processing unit (CPU) 108, a memory 110, a program code 112, and a transceiver 114 of the communications device 100. In the communications device 100, the control circuit 106 executes the program code 112 in the memory 110 through the CPU 108, thereby controlling an operation of the communications device 100. The communications device 100 can receive signals input by a user through the input device 102, such as a keyboard, and can output images and sounds through the output device 104, such as a monitor or speakers. The transceiver 114 is used to receive and transmit wireless signals, delivering received signals to the control circuit 106, and outputting signals generated by the control circuit 106 wirelessly. From a perspective of a communications protocol framework, the transceiver 114 can be seen as a portion of Layer 1, and the control circuit 106 can be utilized to realize functions of Layer 2 and Layer 3. Preferably, the communications device 100 is utilized in a third generation (3G) mobile communications system.

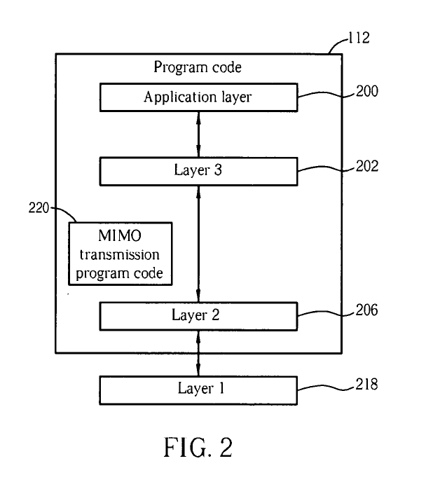

Please continue to refer to FIG. 2. FIG. 2 is a diagram of the program code 112 shown in FIG. 1. The program code 112 includes an application layer 200, a Layer 3 202, and a Layer 2 206, and is coupled to a Layer 1 218. The Layer 3 202 performs resource control, the Layer 2 206 performs link control, and the Layer 1 218 performs physical connections.

As mentioned above, MIMO has been included in LTE, to multiply channel capacity without additional bandwidth or transmit power. In such case, the embodiment of the present invention provides a MIMO transmission program code 220 in the program code 112, utilized for realizing MIMO transmission in LTE.

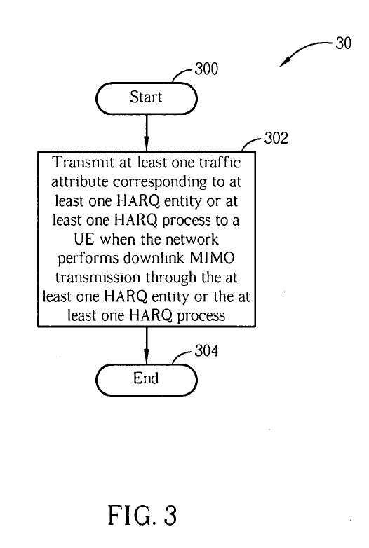

Please refer to FIG. 3, which illustrates a schematic diagram of a process 30. The process 30 is utilized for performing transmission in a network of a wireless communications system. The process 30 can be compiled into the MIMO transmission program code 220, and comprises the following steps:

Step 300: Start.

Step 302: Transmit at least one traffic attribute corresponding to at least one HARQ entity or at least one HARQ process to a UE when the network performs downlink MIMO transmission through the at least one HARQ entity or the at least one HARQ process.

Step 304: End.

According to the process 30, the embodiment of the present invention transmits at least one traffic attribute corresponding to at least one HARQ entity or at least one HARQ process to a UE when the network performs downlink MIMO transmission through the at least one HARQ entity or the at least one HARQ process.

Preferably, in the embodiment of the present invention, the network can transmit the corresponding traffic attribute through a shared channel or a separate according to a result of resource management. The shared channel is used for all HARQ entities or processes at the UE while the lease one separate channel is used for the at least one HARQ entity or the at least one HARQ process.

Moreover, in the embodiment of the present invention, an acknowledgement message corresponding to the downlink transmission from the UE is used for indicating a status of a predefined number of HARQ entities or HARQ processes at UE. The predefined number can be 1 or 2.

Therefore, through the process 30, the embodiment of the present invention can transmit corresponding traffic attribute to the UE when the network performs downlink transmission.

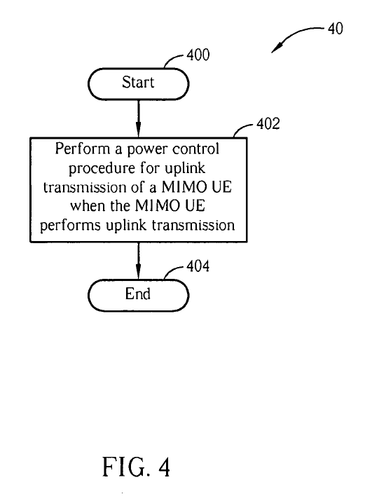

Please refer to FIG. 4, which illustrates a schematic diagram of a process 40. The process 40 is utilized for performing transmission in a network of a wireless communications system. The process 40 can be compiled into the MIMO transmission program code 220, and comprises the following steps:

Step 400: Start.

Step 302: Perform a power control procedure for uplink transmission of a MIMO UE when the MIMO UE performs uplink transmission.

Step 404: End.

According to the process 40, the embodiment of the present invention performs a power control procedure for uplink transmission of a MIMO UE when the MIMO UE performs uplink transmission.

Preferably, in the embodiment of the present invention, the power control procedure can be opened-loop or closed-loop, for setting total power granted for the UE, or power granted at least one or each one of HARQ processes or HARQ entities at the UE.

Moreover, the network can return an acknowledgement message corresponding to the uplink transmission for indicating a status of a predefined number of HARQ entities or HARQ processes at the network. The predefined number can be 1 or 2 according to a MIMO mode of the UE.

Therefore, via the process 40, the embodiment of the present invention can perform the power control procedure for uplink transmission of the MIMO UE when the MIMO UE performs uplink transmission.

In summary, via the embodiment of the present invention, MIMO transmission can be accurately performed.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for performing multi-input multi-output, called MIMO hereinafter, transmission in a network of a wireless communications system, the method comprising:
transmitting at least one traffic attribute corresponding to at least one HARQ entity or at least one HARQ process to a user equipment, called UE hereinafter, when the network performs downlink MIMO transmission through the at least one HARQ entity or the at least one HARQ process.

2. The method of claim 1, wherein transmitting the at least one traffic attribute is transmitting the at least one traffic attribute in a shared channel or at lease one separate channel.

3. The method of claim 2, wherein the shared channel is used for all HARQ entities or processes at the UE while the least one separate channel is used for the at least one HARQ entity or the at least one HARQ process.

4. The method of claim 2 further comprising using the shared channel or the at least one channel according to a result of resource management.

5. The method of claim 1, wherein an acknowledgement message corresponding to the downlink transmission from the UE is used for indicating a status of a predefined number of HARQ entities or HARQ processes at UE.

6. The method of claim 5 further comprising determining the predefined number to be 1 or 2 according to a MIMO mode of the UE.

7. The method of claim 1, wherein the at least one traffic attribute is not sent explicitly based on timing, pilot signal, reception power ratio, scrambling sequence, operated frequency layer or bandwidth.

8. A communications device for accurately performing multi-input multi-output, called MIMO hereinafter, the communications device comprising:
a control circuit for realizing functions of the communications device;
a processor installed in the control circuit, for executing a program code to command the control circuit; and
a memory installed in the control circuit and coupled to the processor for storing the program code;
wherein the program code comprises:
transmitting at least one traffic attribute corresponding to at least one HARQ entity or at least one HARQ process to a user equipment, called UE hereinafter, when the network performs downlink MIMO transmission through the at least one HARQ entity or the at least one HARQ process.

9. The communications device of claim 8, wherein transmitting the at least one traffic attribute is transmitting the at least one traffic attribute in a shared channel or at least one separate channel.

10. The communications device of claim 9, wherein the shared channel is used for all HARQ entities or processes at the UE while the least one separate channel is used for the at least one HARQ entity or the at least one HARQ process.

11. The communications device of claim 9, wherein the program code further comprises using the shared channel or the at least one channel according to a result of resource management.

12. The communications device of claim 8, an acknowledgement message corresponding to the downlink transmission from the UE is used for indicating a status of a predefined number of HARQ entities or HARQ processes at UE.

13. The communications device of claim 12, wherein the program code further comprises determining the predefined number to be 1 or 2 according to a MIMO mode of the UE.

14. A method for performing multi-input multi-output, called MIMO hereinafter, transmission in a network of a wireless communications system, the method comprising:
performing a power control procedure for uplink transmission of a MIMO user equipment, called UE hereinafter, when the MIMO UE performs uplink transmission.

15. The method of claim 14, wherein the power control procedure is opened-loop or closed-loop.

16. The method of claim 14, wherein the power control procedure is utilized for setting total power granted for the UE.

17. The method of claim 14, wherein the power control procedure is utilized for setting power granted for at least one or each one of HARQ processes or HARQ entities at the UE.

18. The method of claim 17, wherein the power control procedure can be implemented on at least one resource block corresponding to the at least one or each one of the HARQ processes.

19. The method of claim 14 further comprising returning an acknowledgement message corresponding to the uplink transmission for indicating a status of a predefined number of HARQ entities or HARQ processes at the network.

20. The method of claim 19, wherein the program code further comprises determining the predefined number to be 1 or 2 according to a MIMO mode of the UE.

21. A communications device for accurately performing multi-input multi-output, called MIMO hereinafter, the communications device comprising:
a control circuit for realizing functions of the communications device;
a processor installed in the control circuit, for executing a program code to command the control circuit; and
a memory installed in the control circuit and coupled to the processor for storing the program code;
wherein the program code comprises:
performing a power control procedure for uplink transmission of a MIMO user equipment, called UE hereinafter, when the MIMO UE performs uplink transmission.

22. The communications device of claim 21, wherein the power control procedure is opened-loop or closed-loop.

23. The communications device of claim 21, wherein the power control procedure is utilized for setting total power granted for the UE.

24. The communications device of claim 21, wherein the power control procedure is utilized for setting power granted for at least one or each one of HARQ processes or HARQ entities at the UE.

25. The communications device of claim 21, wherein the program code further comprises returning an acknowledgement message corresponding to the uplink transmission for indicating a status of a predefined number of HARQ entities or HARQ processes at the network, and determining the predefined number to be 1 or 2 according to a MIMO mode of the UE.
